(19) United States
(12) Patent Application Publication
(10) Pub. No.: US 2018/0101841 A1
(43) Pub. Date: Apr. 12, 2018

(54) METHODS, SYSTEMS, AND COMPUTER READABLE MEDIA FOR EVENT TRIGGERED EXCHANGE OF DIGITAL COMMERCE INSTRUMENTS BETWEEN DIGITAL WALLETS

(71) Applicant: MasterCard International Incorporated, Purchase, NY (US)

(72) Inventor: Manoneet Kohli, O'Fallon, MO (US)

(21) Appl. No.: 15/291,040

(22) Filed: Oct. 11, 2016

(51) Int. Cl. G06Q 20/36; G06Q 30/06; G06Q 20/34

(52) U.S. Cl. CPC G06Q 20/363; G06Q 20/342; G06Q 30/0635; G06Q 30/0631

(57) ABSTRACT

The subject matter described herein relates to methods, systems, and computer readable media for exchanging digital commerce instruments between digital wallets. In some examples, a method includes analyzing a purchase history of a first digital wallet to determine one or more spending patterns for the first digital wallet. The method includes analyzing a repository of digital commerce instruments in a second digital wallet to determine, based on the one or more spending patterns for the first digital wallet and one or more available electronic gifts cards in the repository of digital commerce instruments in the second digital wallet, one or more recommended digital commerce instruments in the second digital wallet for transfer to the first digital wallet. The method includes transferring, over a packet-based data communications network, a selected digital commerce instrument from the second digital wallet to the first digital wallet.

### TECHNICAL FIELD

The subject matter described herein relates generally to computer systems for exchanging digital commerce instruments. More particularly, the subject matter described herein relates to methods, systems, and computer readable media for event triggered exchanging of digital commerce instruments between digital wallets.

### BACKGROUND

Gift cards are staple gifts that one person may give to another in a variety of situations. Gift cards can be useful if the giver is not sure what gift the receiver may want, if there are shipping or other transportation constraints for a gift, as a prize in a contest, or for other reasons. However, traditional physical gift cards still suffer from many of the constraints as traditional gifts. For example, buying the gift card may necessitate a visit to the merchant or a wait on shipping of the card. As a result, some merchants have begun to enable gift givers to send recipients electronic gift cards.

Electronic gift cards can be implemented as a sequence of alphanumeric characters that are generated by a merchant and then distributed to the recipient. The recipient may then use the sequence during a transaction with the merchant. The recipient may also then store electronic gift cards in a digital wallet for the recipient. Much like conventional gift cards, electronic gift cards in a digital wallet may go unused for long periods of time. As a result, the value of the electronic gift cards is not realized by the recipient.

In events, such as parties, graduations, etc., where gifts cards are sometimes exchanged, the giver can purchase and give a physical gift card to the recipient. However, there is currently no known efficient mechanism that facilitates wallet to wallet exchange of electronic gift cards.

In light of these difficulties, there exists a need for methods, systems, and computer readable media for exchanging electronic gift cards between digital wallets.

### SUMMARY

The subject matter described herein relates to methods, systems, and computer readable media for exchanging digital commerce instruments between digital wallets. In some examples, a method includes detecting a trigger condition for digital commerce instrument exchange and, in response to the trigger condition, analyzing a purchase history of a first digital wallet to determine one or more spending patterns for the first digital wallet. The method includes analyzing a repository of digital commerce instruments in a second digital wallet to determine, based on the one or more spending patterns for the first digital wallet and one or more available electronic gifts cards in the repository of digital commerce instruments in the second digital wallet, one or more recommended digital commerce instruments in the second digital wallet for transfer to the first digital wallet. The method includes transferring, over a packet-based data communications network, a selected digital commerce instrument from the second digital wallet to the first digital wallet.

The subject matter described in this specification may be implemented in hardware, software, firmware, or combinations of hardware, software and/or firmware. In some examples, the subject matter described in this specification may be implemented using a non-transitory computer readable medium storing computer executable instructions that when executed by one or more processors of a computer cause the computer to perform operations. Computer readable media suitable for implementing the subject matter described in this specification include non-transitory computer-readable media, such as disk memory devices, chip memory devices, programmable logic devices, random access memory (RAM), read only memory (ROM), optical read/write memory, cache memory, magnetic read/write memory, flash memory, and application specific integrated circuits. In addition, a computer readable medium that implements the subject matter described in this specification may be located on a single device or computing platform or may be distributed across multiple devices or computing platforms.

### BRIEF DESCRIPTION OF THE DRAWINGS

FIG. 1 is a block diagram of an example communications environment for exchanging electronic gift cards between digital wallets;

FIGS. 2A-D are screen shots illustrating a first user interacting with a gift card exchange recommender;

FIGS. 3A-D are screen shots illustrating a second user interacting with the gift card exchange recommender;

FIG. 4 is a block diagram of an example gift card recommender server; and

FIG. 5 is a flow chart of an example method for exchanging electronic gift cards between digital wallets.

### DETAILED DESCRIPTION

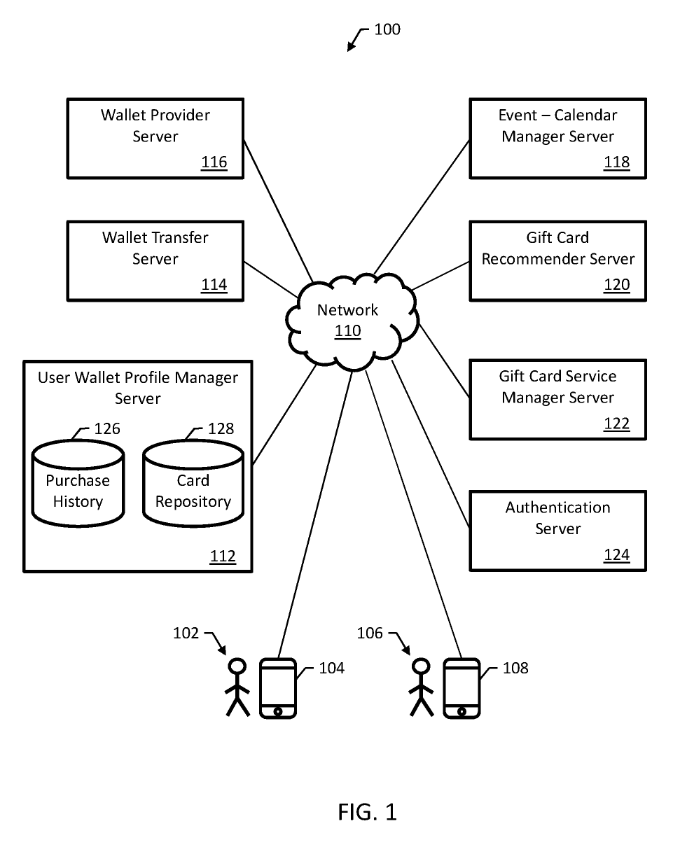

FIG. 1 is a block diagram of an example communications environment 100 for exchanging electronic gift cards between digital wallets. Environment 100 includes a first user 102 operating a first user device 104 and a second user 106 operating a second user device 108. Environment 100 also includes a packet-based data communications network 110, e.g., the Internet, and computer systems that facilitate exchanging electronic gift cards between digital wallets, including a gift card recommender server 120.

First and second users 102 and 106 can exchange electronic gift cards by interacting with user devices 104 and 108. For example, user 102 can send an event invitation to user 106. User 106 can accept the invitation and then decide to get recommendations for transferring an electronic gift card from a digital wallet for user 106 to user 102. Gift card recommender server 120 determines that both user 102 and user 106 have authorized gift card recommendations and then provides recommendations to user 106. User 106 selects a recommended electronic gift card and transfers the selected electronic gift card to a digital wallet for user 102.

Environment 100 includes a user wallet profile manager server 112, a wallet transfer server 114, and a wallet provider server 116. User wallet profile manager server 112, wallet transfer server 114, and wallet provider server 116 are illustrated as being implemented on separate computer systems; however, the functions provided by each system can be implemented on any appropriate distributed computing system. In operation, wallet provider server 116 provides services for users 102 and 106 to set up digital wallets. For example, wallet provider server 116 can provide a graphical user interface (GUI) to user devices 104 and 108 for setting up digital wallets, e.g., by collecting personal and financial information form users 102 and 104.

User wallet profile manager server 112 manages individual user profiles for users 102 and 106. User wallet profile manager server 112 includes a purchase history repository 126 and an electronic gift card repository 128. As users 102 and 106 make purchases using their digital wallets, user wallet profile manager server 112 updates a purchase history for each user in the purchase history repository 126. A purchase history can include, e.g., a time and date for each purchase, and amount for each purchase, and a merchant name for each purchase. As users 102 and 106 acquire electronic gift cards, user wallet profile manager server 112 stores the electronic gift cards in card repository 128. User wallet profile manager server 112 can store other related information, e.g., date each electronic gift card is acquired.

Wallet transfer server 114 manages exchanges between digital wallets. Wallet transfer server 114 can transfer various assets between digital wallets over packet-based data communications network 110, include transferring electronic gift cards. For example, transferring an electronic gift card can include deleting the electronic gift card from the transferring digital wallet, adding the electronic gift card to the receiving digital wallet, and notifying any other appropriate parties such as a merchant computer system where necessary.

In some examples, wallet transfer sever 114 can cause a transfer using a payment network configured for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, and the like. Payment networks may be configured to perform transactions via cash-substitutes, which may include payment cards, letters of credit, checks, financial accounts, and the like.

Environment 100 can include an event-calendar manager server 118, a gift card service manager server 122, and an authentication server 124. Event-calendar manager server 118 manages events and invitations for users 102 and 106. For example, event-calendar manager server 118 can send invitations for events and acceptance and decline notifications in response to invitations. Event-calendar manager server 118 can perform any appropriate calendar management functions and may operate in combination with calendar software executing on user device 104 and 108.

Gift card service manager server 122 provides services for managing electronic gift cards. For example, gift card service manager server 122 can generate sequences of numbers that are used to implement electronic gift cards, associate the numbers with merchants, and track funds associated with the numbers. In some examples, gift card service manager server 122 is associated with a particular merchant or a particular financial institution.

Authentication server 124 authenticates users 102 and 106 to other services in environment 100, e.g., gift card service manager server 122 and gift card recommender server 120. In some examples, authentication server 124 is associated with a particular financial institution and provides a centralized authentication service for various financial transactions. Users 102 and 106 can authenticate to authentication server 124, e.g., using biometric authorization on user devices 104 and 108, or by providing user credentials. After authenticating to authentication server 124, users 102 and 106 can access other services within environment 100 without having to authenticate to each service individually.

In operation, gift card recommender server 120 can provide an electronic gift card recommendation to user 106 for transfer to user 102 by first determining that both users 102 and 106 have authorized the recommendation service. Then, gift card recommender server 120 analyzes the purchase history of the digital wallet for user 102 to determine one or more spending patterns of user 102. Gift card recommender server 120 also analyzes a repository of electronic gifts cards in a digital wallet for user 106 to determine, based on the spending patterns and one or more available electronic gift cards in the repository, one or more recommended electronic gift cards for the transfer. For example, gift card recommender server 120 can communicate with user wallet profile manager server 112 over network 110.

Gift card recommender server 120 can be configured to protect personal information for both users 102 and 106. For example, even though gift card recommender server 120 may access a purchase history for user 102 in determining recommended gift cards, gift card recommender server 120 can be configured to prevent transmission of the purchase history to user 106. Instead, user 106 will only be presented with recommended electronic gift cards. Similarly, gift card recommender server 120 may access a repository of electronic gift cards for user 106, and gift card recommender server 120 can be configured to prevent transmission of any information in the repository to user 102. Gift card recommender server 120 can be configured to allow users to opt-in or opt-out of gift card exchange recommendations, e.g., to opt-out of all gift card exchange recommendations or to opt-out on a case-by-case basis.

Gift card recommender server 120 then transfers, over network 110, a selected electronic gift card from the digital wallet for user 106 to the digital wallet for user 102. For example, gift card recommender server 120 can communicate with wallet transfer server 114 over network 110 to cause wallet transfer server 114 to carry out the transfer.

Environment 100 has been described with reference to the transfer of electronic gift cards for purposes of illustration. Environment 100 can also be configured, by virtue of appropriate programming of the computer systems, for the transfer of other types of digital commerce instruments between digital wallets of different users. In general, the digital commerce instruments used in environment 100 are not tied or bonded to a particular owner and generally can be exchanged with anyone and used seamlessly by the current owner. For example, a digital commerce instrument can also be a reward card, a coupon, or a prepaid card.

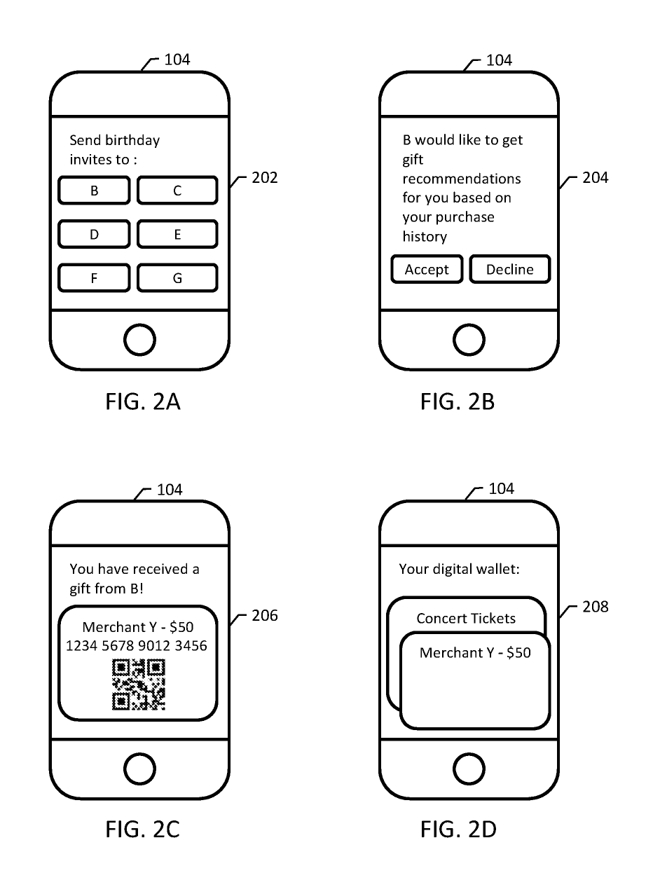

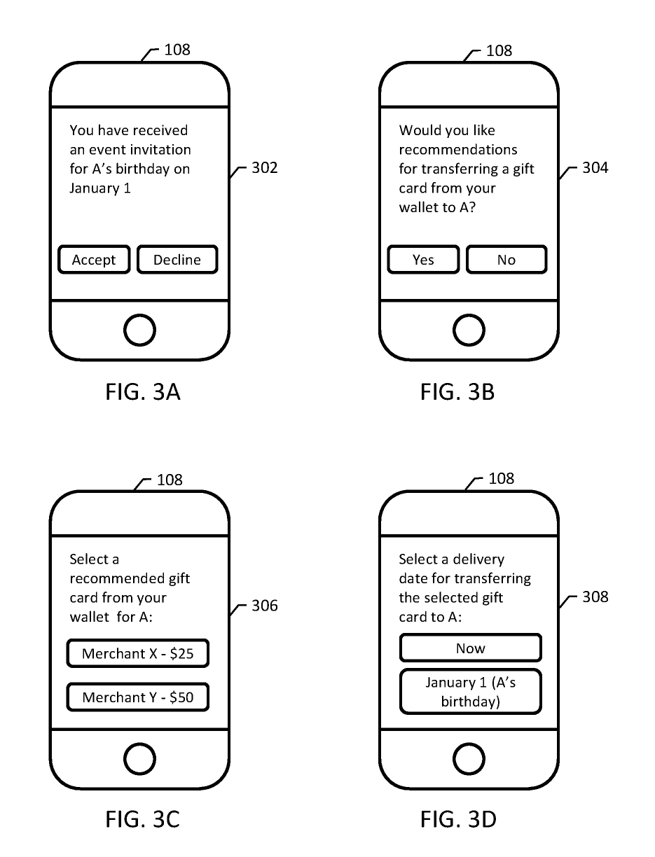

FIGS. 2A-D are screen shots illustrating a first user (user “A”) interacting with a gift card exchange recommender. FIGS. 3A-D are screen shots illustrating a second user (user “B”) interacting with the gift card exchange recommender.

FIGS. 2A-D and 3A-D illustrate an example scenario of user A and user B exchanging a gift card. The screen shots show how the users perceive the exchange. The screens can be displayed on user devices 104 and 106, and user devices 104 and 106 are configured to communicate with a gift card recommender server 120 over a packet-based data communications network 110 to carry out the exchange. In the example scenario, the first user sends an invitation and receives an electronic gift card in the first user's digital wallet. The second user receives the invitation from the first user, gets a recommendation for an electronic gift card to give to the first user, and transfers an electronic gift card from the second user's digital wallet to the first user's digital wallet.

FIG. 2A shows a screen 202 for sending an invitation for user A's birthday event. User A selects recipients for the invitation from a list of contacts and selects at least user B. After user B receives and accepts the invitation, user B elects to receive gift card recommendations. FIG. 2B shows a screen 204 for prompting user A for approval to let user B receive gift card recommendations based on user A's purchase history. User A authorizes the recommendations.

FIG. 2C shows a screen 206 for notifying user A that user B has transferred an electronic gift card in user A's digital wallet. Screen 206 shows the electronic gift card by displaying, for example, the merchant name, the amount, a tracking number for the electronic gift card, and a quick release or other type of graphical code that can be presented to make a purchase using the electronic gift card. FIG. 2D shows a screen 208 that presents the contents of user A's digital wallet, and the contents of user A's digital wallet now include the electronic gift card that was transferred from user B's digital wallet.

FIG. 3A shows a screen 302 for notifying user B that user A has sent user B an event invitation for A's birthday. User B accepts the invitation. FIG. 3B shows a screen 304 for prompting user B for using the gift card recommender server 120. User device 108 can be configured to display screen 304, for example, in response to user B's accepting the invitation and in response to determining that both user B and user A have digital wallets.

FIG. 3C shows a screen 306 for prompting user B to select an electronic gift card from a list of recommended electronic gift cards. The list of recommended electronic gifts cards was generated from gift card recommender server 120 and transmitted to user device 108. User B selects an electronic gift card to transfer from user B's digital wallet to user A's digital wallet. FIG. 3D shows a screen 308 for prompting user B to select a delivery date for transferring the selected electronic gift card to user A's digital wallet. User B can select, e.g., now or on the date of user A's birthday as specified by the event invite.

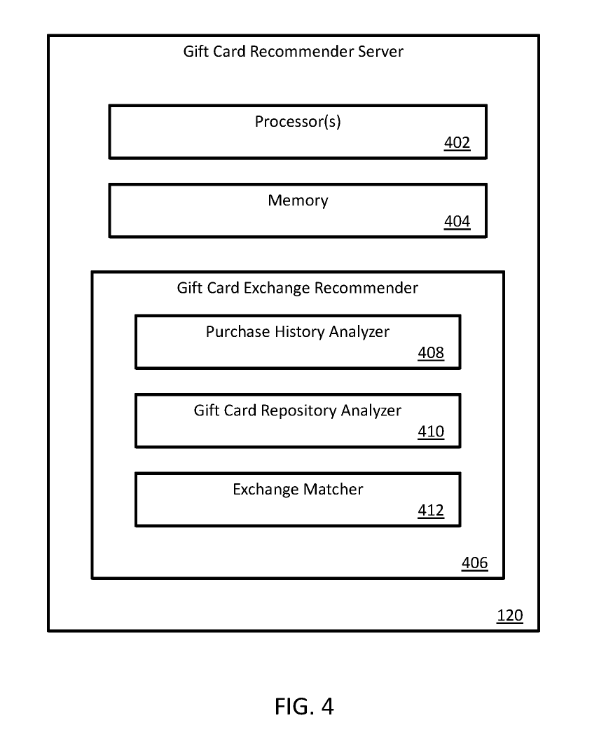

FIG. 4 is a block diagram of an example gift card recommender server 120. Gift card recommender server 120 includes one or more processors 402 and memory 404. The memory stores instructions for processors 402 that can be loaded, e.g., into random access memory (RAM), and executed by processors 402 to cause processors 402 to perform operations for recommending electronic gifts cards to transfer between digital wallets.

Gift card recommender server 102 includes a gift card exchange recommender 406 implemented by processors 402 and memory 404. Gift card exchange recommender 406 includes a purchase history analyzer 408, a gift card repository analyzer 410, and an exchange matcher 412. In operation, gift card exchange recommender 406 verifies that two users with digital wallets have authorized gift card exchange recommender 406 to provide recommendations for an exchange and then uses purchase history analyzer 408, gift card repository analyzer 410, and exchange matcher 412 to provide recommendations.

Purchase history analyzer 408 is configured to analyze a purchase history of a first digital wallet to determine one or more spending patterns for the first digital wallet. For example, analyzing the purchase history of the first wallet can include identifying a merchant based on a number of purchases from the merchant in the purchase history of the first digital wallet. Identifying the merchant can include, e.g., determining a number of purchases for each merchant in the purchase history and identifying the merchant having a highest number of purchases in the purchase history, or a number of merchants having a number of purchases above a threshold number of purchases.

In another example, analyzing the purchase history of the first wallet can include identifying a target price range based on a number of purchases within the target price range in the purchase history of the first digital wallet. Identifying the target price range can include, e.g., subdividing the purchase history into a plurality of price ranges, counting a number of purchases within each price range, and identifying the target price range as the price range having the greatest number of purchases, or identifying a number of target price ranges have a number of purchases that exceeds a threshold.

Gift card repository analyzer 410 is configured to analyze a repository of electronic gift cards in a second digital wallet to determine available gift cards to recommend for transferring. For example, gift card repository analyzer 410 can search the second digital wallet for electronic gift cards that are designated as transferable by merchants issuing the electronic gift cards. Gift card repository analyzer 410 can search the second digital wallet for electronic gift cards having at least a minimum remaining balance. Gift card repository analyzer 410 can search the second digital wallet for electronic gifts cards having an expiration date that has not yet been exceeded.

Exchange matcher 412 is configured to determine recommended gift cards for transferring from the second digital wallet to the first digital wallet. Exchange matcher 412 uses purchase history analyzer 408 to determine what kinds of electronic gift cards the user of the first digital wallet may appreciate and exchange matcher 412 uses gift card repository analyzer 410 to determine which electronic gift cards the user of the second digital wallet is in possession of that the user of the first digital wallet may appreciate. In general, exchange matcher 412 can use any appropriate algorithm or machine learning technology for finding matches.

For example, where purchase history analyzer 408 identifies one or more merchants, exchange matcher 412 can find available electronic gift cards redeemable at the merchants. In another example, where purchase history analyzer 408 identifies one or more price ranges, exchange matcher 412 can find available electronic gift cards having amounts remaining that are within the price ranges.

In some examples, gift card exchange recommender 406 determines recommended gift cards without using purchase history analyzer 408. For example, gift card exchange recommender 406 may determine recommended gift cards using only gift card repository analyzer 410. This feature may be useful, for example, where the purchase history for a digital wallet is not available, or where a user has configured gift card exchange recommender 406 to not use purchase histories. In these examples, gift card exchange recommender 406 determines recommendations based on information for items in the second digital wallet. For example, the recommendations can be based on an un-used lifetime of a gift card or an approaching expiration date of a gift card.

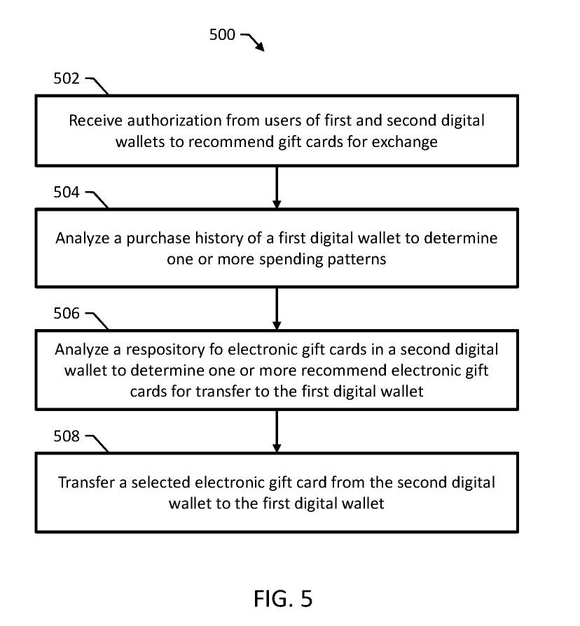

FIG. 5 is a flow chart of an example method 500 for exchanging electronic gift cards or other types of certificates between digital wallets. Method 500 is performed by a system of one or more computers configured, by virtue of appropriate programming, to recommend electronic gift cards to transfer from one digital wallet to another. For example, the gift card recommender server 120 of FIG. 1 can perform method 500.

The system receives authorization from users of first and second digital wallets to recommend gift cards for exchange (502). For example, the system can receive authorization from the authentication server 124 of FIG. 1. The users can authenticate to the authentication server using any appropriate technology, e.g., biometric technology. The system can request authorization from the users in response to detecting a trigger condition, for example, in response to receiving an event message. The event message can be any appropriate type of event message, e.g., an event invite message or an event notification message or an event response message.

The system analyzes a purchase history of a first digital wallet to determine one or more spending patterns of the first digital wallet (504). For example, analyzing the purchase history of the first digital wallet to determine the one or more spending patterns for the first digital wallet can include identifying a merchant based on a number of purchases from the merchant in the purchase history of the first digital wallet. Identifying the merchant based on a number of purchases from the merchant in the purchase history of the first digital wallet can include determining a number of purchases from each merchant in the purchase history and identifying the merchant having a highest number of purchases in the purchase history.

In another example, analyzing the purchase history of the first digital wallet to determine the one or more spending patterns for the first digital wallet can include identifying a target price range based on a number of purchases within the target price range in the purchase history of the first digital wallet. Identifying the target price range can include subdividing the purchase history into price ranges, counting a number of purchases within each price range, and identifying the target price range as the price range having the greatest number of purchases.

The system analyzes a repository of electronic gift cards in a second digital wallet to determine, based on the one or more spending patterns for the first digital wallet and one or more available electronic gift cards in the repository of electronic gifts cards in the second digital wallet, one or more recommended electronic gift cards in the second digital wallet for transfer to the first digital wallet (506). For example, analyzing the repository of electronic gift cards in the second digital wallet to determine the one or more recommended electronic gift cards can include identifying an electronic gift card for a particular merchant in the repository of electronic gift cards in the second wallet. In another example, analyzing the repository of electronic gift cards in the second digital wallet to determine the one or more recommended electronic gift cards can include identifying an electronic gift card having an available amount within a target price range in the repository of electronic gift cards in the second digital wallet.

The system transfers a selected electronic gift card from the second digital wallet to the first digital wallet (508). For example, the system can use the wallet transfer server 114 of FIG. 1. In some examples, the system receives receiving an event invite message from a first user device of the first digital wallet over the packet-based data communications network. The system analyzes the purchase history of the first digital wallet and analyzes the repository of electronic gift cards in the second digital wallet in response to receiving the event invite message. Transferring the selected electronic gift card from the second digital wallet to the first digital wallet can include transferring the selected electronic gift card at a time specified in the event invite message or at a location specified in the event invite message. A user device can be programmed to check the current location using any appropriate technology, e.g., a global positioning system (GPS) receiver, and cause the transfer to occur in response to the user bringing the user device to the location.

Accordingly, while the methods, systems, and computer readable media have been described herein in reference to specific embodiments, features, and illustrative embodiments, it will be appreciated that the utility of the subject matter is not thus limited, but rather extends to and encompasses numerous other variations, modifications and alternative embodiments, as will suggest themselves to those of ordinary skill in the field of the present subject matter, based on the disclosure herein.

Various combinations and sub-combinations of the structures and features described herein are contemplated and will be apparent to a skilled person having knowledge of this disclosure. Any of the various features and elements as disclosed herein may be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims.

It is understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method comprising:
detecting a trigger condition for digital commerce instrument exchange; and
in response to the trigger condition:
analyzing, by a certificate exchange recommender implemented on at least one processor, a purchase history of a first digital wallet to determine one or more spending patterns for the first digital wallet;
analyzing, by the certificate exchange recommender, a repository of digital commerce instruments in a second digital wallet to determine, based on the one or more spending patterns for the first digital wallet and one or more available digital commerce instruments in the repository of digital commerce instruments in the second digital wallet, one or more recommended digital commerce instruments in the second digital wallet for transfer to the first digital wallet; and
transferring, by the certificate exchange recommender and over a packet-based data communications network, a selected digital commerce instrument from the second digital wallet to the first digital wallet, the selected digital commerce instrument selected from the one or more recommended digital commerce instruments.

2. The method of claim 1, wherein analyzing the purchase history of the first digital wallet to determine the one or more spending patterns for the first digital wallet comprises identifying a merchant based on a number of purchases from the merchant in the purchase history of the first digital wallet.

3. The method of claim 2, wherein identifying the merchant based on a number of purchases from the merchant in the purchase history of the first digital wallet comprises determining a number of purchases from each candidate merchant of a plurality of candidate merchants specified in the purchase history and identifying the candidate merchant having a highest number of purchases in the purchase history.

4. The method of claim 2, wherein analyzing the repository of digital commerce instruments in the second digital wallet to determine the one or more recommended digital commerce instruments comprises identifying an digital commerce instrument for the merchant in the repository of digital commerce instruments in the second wallet.

5. The method of claim 1, wherein analyzing the purchase history of the first digital wallet to determine the one or more spending patterns for the first digital wallet comprises identifying a target price range based on a number of purchases within the target price range in the purchase history of the first digital wallet.

6. The method of claim 5, wherein identifying the target price range comprises subdividing the purchase history into a plurality of price ranges, counting a number of purchases within each price range, and identifying the target price range as the price range having the greatest number of purchases.

7. The method of claim 5, wherein analyzing the repository of digital commerce instruments in the second digital wallet to determine the one or more recommended digital commerce instruments comprises identifying an digital commerce instrument having an available amount within the target price range in the repository of digital commerce instruments in the second digital wallet.

8. The method of claim 1, wherein detecting the trigger condition comprises receiving an event invite message from a first user device of the first digital wallet over the packet-based data communications network.

9. The method of claim 8, wherein transferring the selected digital commerce instrument from the second digital wallet to the first digital wallet comprises transferring the selected digital commerce instrument at a time specified in the event invite message or at a location specified in the event invite message.

10. The method of claim 8, comprising displaying an event invite prompt to a user of the first digital wallet on a second user device, receiving input from the user on the second user device indicating acceptance of the invite and, in response, sending an event acceptance message to the first user device over the packet-based data communications network and displaying a certificate recommendations prompt to the user on the second user device.

11. A system comprising:
at least one processor; and
a certificate exchange recommender implemented on the at least one processor and configured for detecting a trigger condition for digital commerce instrument exchange and, in response to the trigger condition:
analyzing a purchase history of a first digital wallet to determine one or more spending patterns for the first digital wallet;
analyzing a repository of digital commerce instruments in a second digital wallet to determine, based on the one or more spending patterns for the first digital wallet and one or more available electronic gifts cards in the repository of digital commerce instruments in the second digital wallet, one or more recommended digital commerce instruments in the second digital wallet for transfer to the first digital wallet; and
transferring, over a packet-based data communications network, a selected digital commerce instrument from the second digital wallet to the first digital wallet, the selected digital commerce instrument selected from the one or more recommended digital commerce instruments.

12. The system of claim 11, wherein analyzing the purchase history of the first digital wallet to determine the one or more spending patterns for the first digital wallet comprises identifying a merchant based on a number of purchases from the merchant in the purchase history of the first digital wallet.

13. The system of claim 12, wherein identifying the merchant based on a number of purchases from the merchant in the purchase history of the first digital wallet comprises determining a number of purchases from each candidate merchant of a plurality of candidate merchants specified in the purchase history and identifying the candidate merchant having a highest number of purchases in the purchase history.

14. The system of claim 12, wherein analyzing the repository of digital commerce instruments in the second digital wallet to determine the one or more recommended digital commerce instruments comprises identifying an digital commerce instrument for the merchant in the repository of digital commerce instruments in the second wallet.

15. The system of claim 11, wherein analyzing the purchase history of the first digital wallet to determine the one or more spending patterns for the first digital wallet comprises identifying a target price range based on a number of purchases within the target price range in the purchase history of the first digital wallet.

16. The system of claim 15, wherein identifying the target price range comprises subdividing the purchase history into a plurality of price ranges, counting a number of purchases within each price range, and identifying the target price range as the price range having the greatest number of purchases.

17. The system of claim 15, wherein analyzing the repository of digital commerce instruments in the second digital wallet to determine the one or more recommended digital commerce instruments comprises identifying an digital commerce instrument having an available amount within the target price range in the repository of digital commerce instruments in the second digital wallet.

18. The system of claim 11, wherein the certificate exchange recommender is configured for receiving an event invite message from a first user device of the first digital wallet over the packet-based data communications network, and wherein analyzing the purchase history of the first digital wallet and analyzing the repository of digital commerce instruments in the second digital wallet comprises analyzing the purchase history of the first digital wallet and analyzing the repository of digital commerce instruments in the second digital wallet in response to receiving the event invite message.

19. The system of claim 8, wherein transferring the selected digital commerce instrument from the second digital wallet to the first digital wallet comprises transferring the selected digital commerce instrument at a time specified in the event invite message or at a location specified in the event invite message.

20. The system of claim 8, wherein the certificate recommender is configured for displaying an event invite prompt to a user of the first digital wallet on a second user device, receiving input from the user on the second user device indicating acceptance of the invite and, in response, sending an event acceptance message to the first user device over the packet-based data communications network and displaying a certificate recommendations prompt to the user on the second user device.

21. One or more non-transitory computer readable mediums storing instructions for at least one processor that, when executed by the at least one processor, cause the at least one processor to detect a trigger condition for digital commerce instrument exchange and, in response to the trigger condition perform operations comprising:
analyzing a purchase history of a first digital wallet to determine one or more spending patterns for the first digital wallet;
analyzing a repository of digital commerce instruments in a second digital wallet to determine, based on the one or more spending patterns for the first digital wallet and one or more available electronic gifts cards in the repository of digital commerce instruments in the second digital wallet, one or more recommended digital commerce instruments in the second digital wallet for transfer to the first digital wallet; and
transferring, over a packet-based data communications network, a selected digital commerce instrument from the second digital wallet to the first digital wallet, the selected digital commerce instrument selected from the one or more recommended digital commerce instruments.
